(19) United States
(12) Patent Application Publication
(10) Pub. No.: US 2006/0085584 A1
(43) Pub. Date: Apr. 20, 2006

(54) Multi-function ultrabase

(75) Inventors: Ching-Jou Chen, Taipei City (TW); Tzu-Wei Lai, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/114,144

(22) Filed: Apr. 26, 2005

(30) Foreign Application Priority Data
Oct. 15, 2004 (TW) 093216488

(51) Int. Cl. G06F 13/00

(52) U.S. Cl. 710/303

(57) ABSTRACT

A multi-function ultrabase comprises a base member, a Mass Storage Device Interface, at least one Universal Serial Bus (USB), and a plurality of connectors (PS/2 connector and COM ports). Wherein, the USB connector is locate at the base member for connecting with a notebook or a desktop; An Integrated Device Electronics (IDE) Interface is located at the base member to connect to a Mass Storage Device and to couple the base member and the Mass Storage Device. The Mass Storage Device can be connected to the computer device by the USB connector; A plurality of connectors are located at the base member for connecting multiple related I/O device. Making the multiple related I/O device connect to the computer device by the USB connector.

### BACKGROUND OF THE INVENTION

1. Field of the Invention

The present invention relates to an ultrabase and more particularly, to a multi-function ultrabase applied to a notebook or a desktop.

2. Description of Related Art

The ultrabase currently sold on the market can only work with the notebook of the same brand and model. As show in FIG. 1 for example, the ultrabase 1 and the notebook 2 have to have the same interface to connect each other. Normally speaking, the ultrabase 1 cannot be connected to notebooks of different brands or models, but those of the same brand and model. And the ultrabase is totally out of function once it separates from the notebook. The ultrabase could neither work solely nor connect to other desktops, which limits the usage of the ultrabase.

In addition, the slim DVD/CD Driver has to be Built-in the notebook, such as connecting to the computer by Integrated Device Electronics (IDE). However, the slim DVD/CD Driver has to be taken out when replacing a new one. The separate traditions slim DVD/CD Driver cannot be connected to a desktop nor has an appropriate ultrabase to connect to other computers, which makes a waste of the resource.

Therefore, it is desirable to provide a multi-function ultrabase that eliminates the aforesaid problems.

### SUMMARY OF THE INVENTION

The object of the present invention is to provide a multi-function ultrabase to connect multiple related I/O device, Related I/O device is connected to the computer device by ultrabase.

It is another object of the present invention is to provide a multi-function ultrabase which has a Mass Storage Device Interface (IDE) to connect the Mass Storage Device (Disk Driver), Wherein, The Mass Storage Device (Disk Driver) connect to a computer device by a Universal Serial Bus (USB) connector.

To achieve these and other objects of the present invention, the multi-function ultrabase comprises a base member; at least one USB connector, a Mass Storage Device Interface(IDE), and A plurality of connectors (PS/2 [symbol] COM ports [symbol] USB). The USB connector is located at the base member to be able to connect a computer device. The Mass Storage Device Interface is located at the base member to connect a Mass Storage Device and furthermore. The Mass Storage Device can connect to the computer device by an USB connector. A plurality of connectors are located at the base member. In order to connect multiple related I/O device, that connect to the computer device by an USB connector.

Wherein, the above multi-function ultrabase includes a left part and a right part. The left part connects to the right part by a pivot, which make the base member bendable and easier to couple with a Mass Storage Device.

It is to be understand that both the foregoing general description and the following detailed description are exemplary and explanatory and are intended to provide further explanation of the invention as claimed.

### BRIEF DESCRIPTION OF THE DRAWINGS

FIG. 1 is a schematic drawing showing the connection of an ultrabase and a notebook as already known.

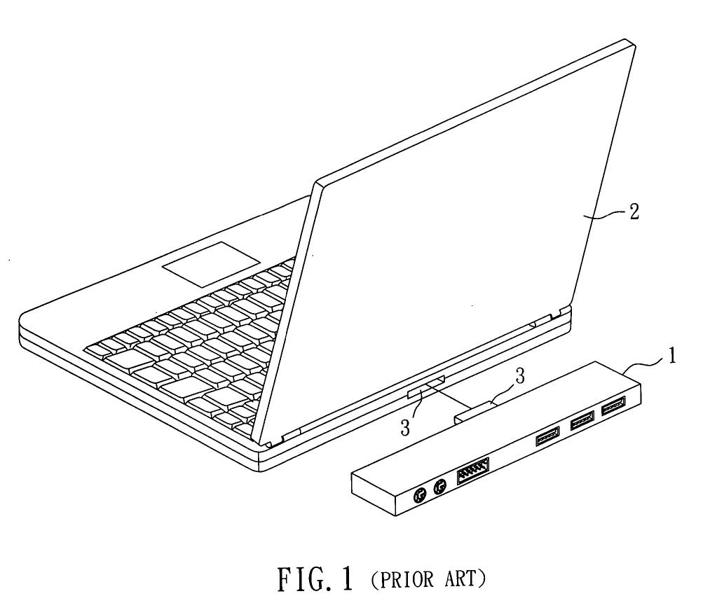

FIG. 2 is a structural view of a multi-function ultrabase in accordance with the preferred embodiment of the present invention.

FIG. 3 is a schematic drawing showing the connection of a Mass Storage Device and a computer device in accordance with the preferred embodiment of the present invention.

FIG. 4 is a schematic drawing showing the connection of a Mass Storage Device and a computer device in accordance with the preferred embodiment of the present invention.

FIG. 5 is a schematic drawing showing the connection of related I/O device and a computer device in accordance with the preferred embodiment of the present invention.

### DETAILED DESCRIPTION OF THE PREFERRED EMBODIMENT

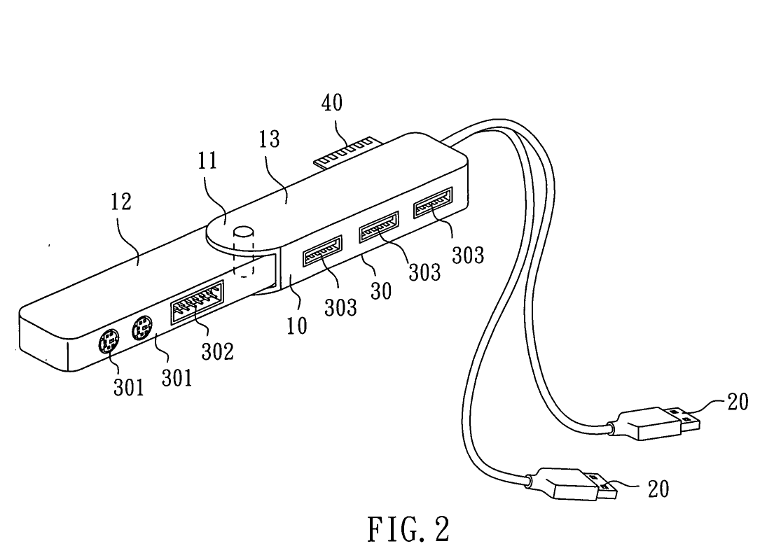

Referring to FIG. 2, the multi-function ultrabase comprises a base member 10, at least one Universal Serial Bus (USB) connector 20, A plurality of connectors 301, 302, 303 (such as PS/2 connector, COM ports, and USB), and a Mass Storage Device Interface 40(IDE), wherein the base member 10 comprises a left part 12 and a right part 13. The left part 12 and the right part 13 connect to each other by a pivot 11, which make the base member 10 bendable to form a shape of L. An Integrated Device Electronics (IDE) Interface 40 is located at inside of the base member 10 to make it easier to connect a Mass Storage Device 50, such as a notebook or a desktop. The A plurality of connectors 301, 302, 303 are located at the base member 10 to connect related I/O device.

The above USB connector 20 is located at the base member 10 for connecting the multi-function ultrabase and the computer device, (such as a tablet PC, a desktop or a notebook . . . etc), and provides electricity to the multi-function ultrabase.

The above A plurality of connectors 301˜303 are PS/2 connector, COM ports, USB connector . . . etc., which are located at the base member 10 to connect related I/O device, (such as a mouse, a keyboard, and a printer, . . . etc) to a computer device by the USB connector 20.

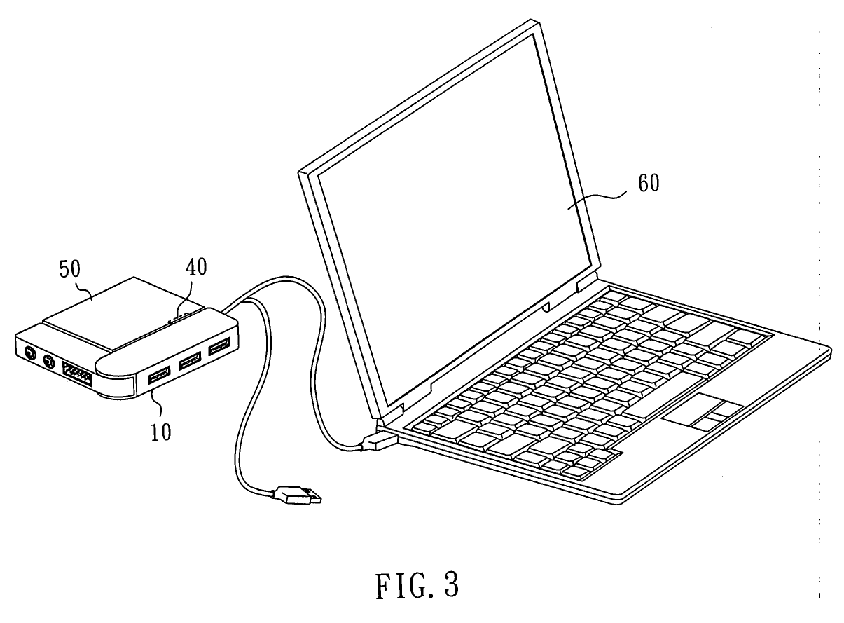

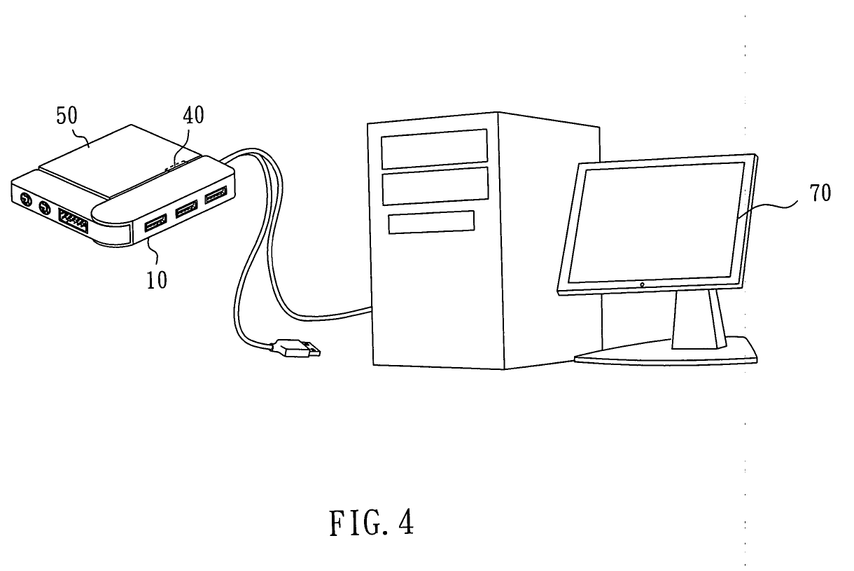

Referring to FIG. 3 and FIG. 4, the above IDE Interface 40 is located at the base member 10 to connect a Mass Storage Device 50. When coupling the IDE Interface 40 with the Mass Storage Device 50, (such as slim DVD/CD Driver or 2.5 inch Hard Disk Driver), the base member 10 can be bent to form a L-shape to combine with the Mass Storage Device 50. The Mass Storage Device 50 can connect to the base member 10 by an IDE Interface 40 and further connect to a notebook 60 or a desktop 70 by a USB connector 20. As a result, by combining the multi-function ultrabase of the present invention and the Mass Storage Device 50, the present invention provides an external Mass Storage Device 50 for the use of a computer.

The above IDE Interface 40 is the Integrated Device Electronics Interface of notebook. The Mass Storage Device 50 can be a slim DVD/CD Driver or a 2.5 inch Hard Disk Driver. The base member 10 comprises a left part 12 and a right part 13. The left part 12 and the right part 13 connect to each other by a pivot 11, which make the base member 10 bendable to form a shape of L. Therefore, the slim DVD/CD Driver or Hard Disk Driver can be utilized thoroughly by coupling the L-shape multi-function ultrabase with the Mass Storage Device 50, as shown in FIG. 3 and FIG. 4.

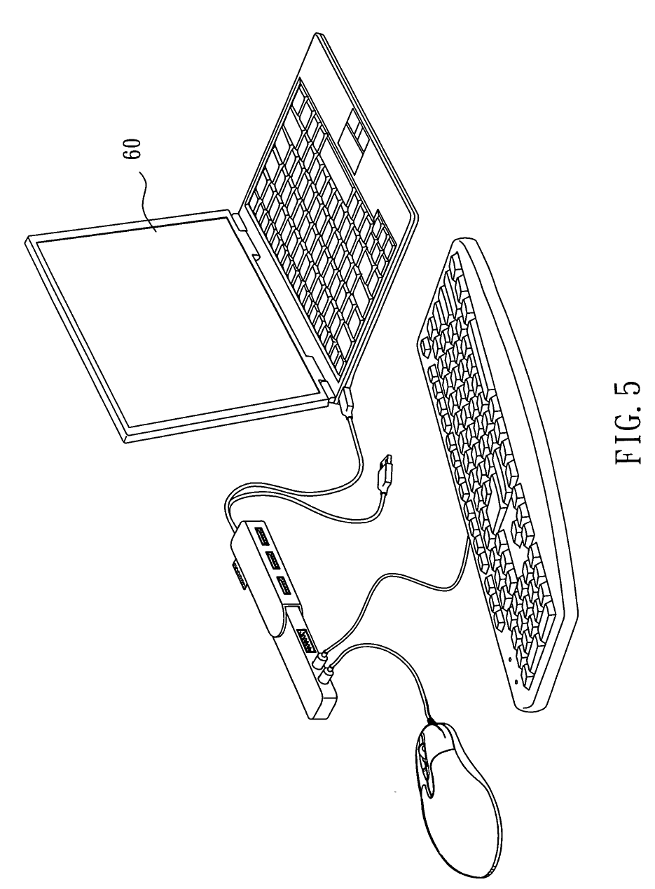

Referring to FIG. 5, Mouse, keyboard or printer can be connected to a computer device by A plurality of connectors 301˜303 to transmit information.

Although the present invention has been explained in relation to its preferred embodiment, it is to be understood that many other possible modifications and variations can be made without departing from the spirit and scope of the invention as hereinafter claimed.

What is claimed is:

1. A multi-function ultrabase comprising:
a base member;
at least one Universal Serial Bus connector (USB), said USB connector is located at said base member for connecting a computer device;
a Mass Storage Device Interface, said Mass Storage Device Interface is located at said base member, and said Mass Storage Device is connected to said computer device by said USB connector; and
A plurality of connectors connectors, said A plurality of connectors are located at said base member in order to connect multiple related I/O device, and said multiple related I/O device connected to said computer device by said USB connector.

2. The multi-function ultrabase of claim 1, wherein said A plurality of connectors connectors comprise at least one of the following: a PS/2 connector, COM ports or an USB Interface.

3. The multi-function ultrabase of claim 1, wherein said Mass Storage Device Interface is an Integrated Device Electronics Interface (IDE).

4. The multi-function ultrabase of claim 1, wherein said Mass Storage Device is a slim DVD/CD Driver for a notebook.

5. The multi-function ultrabase of claim 1, wherein said Mass Storage Device is a 2.5 inch Hard Disk Driver.

6. The multi-function ultrabase of claim 1, wherein said base member comprises a left part and a right part, wherein said left part is connected to said right part by a pivot in order to bent said base member and to connect said Mass Storage Device.

7. The multi-function ultrabase of claim 1, wherein said computer device is a notebook.

8. The multi-function ultrabase of claim 1, wherein said computer device is a desktop.
